(19) United States
(12) Patent Application Publication
(10) Pub. No.: US 2012/0005055 A1
(43) Pub. Date: Jan. 5, 2012

(54) DYNAMIC COMPUTATION OF ROI FOR TEST AUTOMATION

(75) Inventor: Monica Luke, Littleton, MA (US)

(73) Assignee: INTERNATIONAL BUSINESS MACHINES CORPORATION, Armonk, NY (US)

(21) Appl. No.: 12/828,269

(22) Filed: Jun. 30, 2010

(51) Int. Cl. G06Q 40/00; G06F 9/44

(52) U.S. Cl. 705/35; 717/126

(57) ABSTRACT

Embodiments of the present invention provide a method, system and computer program product for dynamic computation of return on investment (ROI) for test automation. In an embodiment of the invention, a method for dynamic computation of ROI for test automation can include storing a development cost for an automated test tool configured to test an application under test, and also a cost of manually executing a test case for the application under test. The method also can include repeatedly executing the automated test tool for the application under test. Of note, the method can include computing a running ROI as a difference between a number of executions of the automated test tool by the cost of manually executing the test case for the application under test less the development cost of the automated test tool divided by the development cost. Finally, the method can include displaying the running ROI.

### BACKGROUND OF THE INVENTION

1. Field of the Invention

The present invention relates to software test automation and more particularly to return on investment (ROI) calculation for the use of test automation for an application under test.

2. Description of the Related Art

The software development lifecycle describes the model for the lifespan of a computer program. The lifecycle model begins with the specification of requirements for the application, the design and implementation of the application, the verification of the design and implementation according to the specified requirements, and the maintenance of the program once fielded to the end user. Part and parcel of the verification portion of the lifecycle includes software testing. Although manual tests may find many defects in a software application, manual testing can be both laborious and time consuming. In addition, manual testing may not be effective in finding particular classes of defects.

Test automation is a process of writing a computer program to perform testing that would otherwise need to be done manually. Once tests have been automated, the test can be run quickly. Consequently, automated testing can be the most cost effective method for testing software products having a long maintenance lifespan, because even minor patches over the lifetime of the application can cause features to break which had been operating nominally at an earlier point in time. There are two general approaches to test automation: code-driven testing and graphical user interface testing. In code-driven testing, the accessible interfaces to classes, modules, or libraries of the application under test are exercised with a variety of input arguments to validate that the results returned are correct. By comparison, in graphical user interface testing, a testing framework generates user interface events such as keystrokes and mouse clicks, and observes the changes that result in the user interface, to validate that the observable behavior of the program is correct.

Test automation tools can be expensive, and are usually employed in combination with manual testing. However, the use of test automation tools can be made cost-effective in the longer term, especially when used repeatedly in regression testing. To measure the cost effectiveness of a test automation tool, ROI calculators have been developed strictly to compute the savings produced by automating manual testing of software. Generally, ROI calculators require the manual collection of input values for submission to the ROI calculator in order to generate a result. Most ROI calculators are complex and include many static expenses like tool costs. Yet, the true measure of ROI occurs over time as automated testing of an application matures during the maintenance lifecycle of an application under test. Thus, while the static production of ROI metrics for an application under test can be helpful, the static production of ROI metrics alone does not paint a true picture of the cost-effectiveness of the use of a test automation tool.

### BRIEF SUMMARY OF THE INVENTION

Embodiments of the present invention address deficiencies of the art in respect to ROI calculators for test automation tools and provide a novel and non-obvious method, system and computer program product for dynamic computation of ROI for test automation. In an embodiment of the invention, a method for dynamic computation of ROI for test automation can include storing a development cost for an automated test tool configured to test an application under test, and also a cost of manually executing a test case for the application under test. The method also can include repeatedly executing the automated test tool for the application under test. Of note, the method can include computing a running ROI as a difference between a number of executions of the automated test tool by the cost of manually executing the test case for the application under test less the development cost of the automated test tool divided by the development cost. Finally, the method can include displaying the running ROI.

In one aspect of the embodiment, storing a development cost for an automated test tool configured to test an application under test can include developing the automated test tool in a test planning and execution environment and tracking during development an amount of time lapsing during the development. Further, the development cost for the automated test tool can be tracked and stored as a multiple of the amount of time lapsed during development. Alternatively, computing the development cost for the automated test tool as a multiple of the amount of time lapsed during development can include computing the development cost for the automated test tool as a multiple of the amount of time lapsed during development added to a cost of computing resource consumed by the test planning and execution environment during development.

In another embodiment of the invention, a test automation data processing system can be configured for dynamic computation of ROI for test automation. The system can include a host computer with at least one processor and memory and an operating system hosted by the host computer. The system also can include an automated test tool executing in the host computer through the operating system, the automated test tool testing an application under test. Finally, the system can include a dynamic ROI calculator coupled to the automated test tool. The ROI calculator can include program code enabled upon execution in the host computer to compute a running ROI for the automated test tool as a difference between a number of uses of the automated test tool by a cost of manual execution of a test case for the application under test less a development cost of the automated test tool divided by the development cost automated test tool, and to display the running ROI through the host computer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for dynamic computation of ROI for test automation;

FIG. 2 is a schematic illustration of a test automation data processing system configured for dynamic computation of ROI for test automation; and,

FIG. 3 is a flow chart illustrating a process for dynamic computation of ROI for test automation.

### DETAILED DESCRIPTION OF THE INVENTION

Embodiments of the invention provide for dynamic computation of ROI for test automation. In accordance with an embodiment of the invention, a test case can be established and a metric can be assigned to the test case as a cost of manual execution of the test case. An automated test tool can be developed and a metric can be determined for the costs of developing the automated test tool. By way of example, a time consumed in developing the automated test tool can be recorded from within a development environment for the automated test tool. Thereafter, at each execution of the automated test tool, an ROI for the automated test tool can be computed and reported according to the difference between an aggregation of all instances of execution of the automated test tool by the metric for the cost of manual execution of the test case less the metric for the costs of developing the automated test tool, divided by the metric for the cost of manual execution of the test case less the metric for the costs of developing the automated test tool.

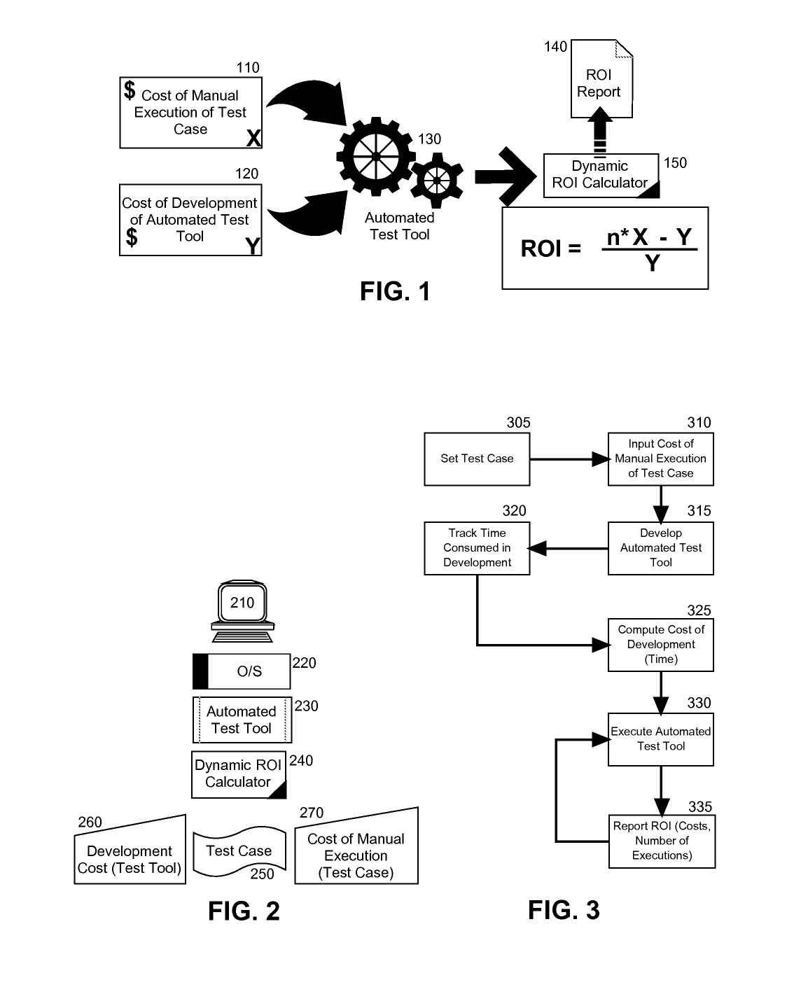

In further illustration, FIG. 1 is a pictorial illustration of a process for dynamic computation of ROI for test automation. As shown in FIG. 1, a test case can be established for an application under test. The cost of manually executing the test case 110 on the application under test can be determined, for example by determining a number of man-hours necessary to complete the manual execution of the test case and the amount of computing resources consumed in the course of completing the manual execution of the test case. Also, an automated test tool 130 can be developed and the cost of development 120 of the automated test tool 130 can be determined, for example by tracking the number of man-hours expended in the course of developing the automated test tool 130 and any computing resources consumed.

Thereafter, whenever the automated test tool 130 performs an automated test of the application under test, dynamic ROI calculator 150 can compute a running ROI for the automated test tool 130. Specifically, the ROI can be computed by the dynamic ROI calculator 150 as the difference between a number of uses of the automated test tool 130 by the cost of manual execution 110 less the cost of development 120 divided by the cost of development 120. Subsequently, the running ROI can be presented in connection with the use of the automated test tool 130 in a display or in an ROI report 140. In this way, the favorable impact on ROI of the repeated use of the automated test tool 130 will be apparent concurrently with the use of the automated test tool 130.

The process described in connection with FIG. 1 can be implemented within a test automation data processing system. As shown in FIG. 2, a test automation data processing system can be configured for dynamic computation of ROI for test automation. The system can include a host computer 210 supporting the execution of an operating system 220. The operating system 220 in turn can host the operation of an automated test tool 230 developed to perform automated testing of an application under test according to one or more test cases 250.

The automated test tool 230 can be developed according to a test plan within a test planning and execution environment (not shown) and the time expended during the development of the automated test tool 230 can be tracked within the environment and converted through computation into a development cost 260 for the automated test tool 230. Concurrently, a cost of manual execution of the test case 270 can be established. Of note, a dynamic ROI calculator 240 coupled to the automated test tool 230 can utilize the development cost 260 and the cost of manual execution 270 of the test case 250 to produce a dynamic measure of ROI for the use of the automated test tool 230 each time the automated test tool 230 is used to automate the testing of the application under test. In this regard, the dynamic ROI calculator 240 can include program code enabled upon execution in the host computer 210 to compute a running ROI as the difference between a number of uses of the automated test tool 230 by the cost of manual execution 270 less the development cost 260 divided by the development cost 260, and to display the running ROI in a report or in a display of the host computer 210. Optionally, a cost of maintenance of the automated test tool 230 can be added into the development cost 260 as function of time expended modifying the automated test tool 230 from time to time during the course of maintaining the automated test tool 230.

In even yet further illustration, FIG. 3 is a flow chart illustrating a process for dynamic computation of ROI for test automation. The process can begin in block 305 with the establishment of a test case for an application under test and the provision of the cost of manually executing the test case in block 310. In block 315, the automated test tool can be developed and the time expended to do so can be recorded in block 320. In block 325, the development cost for the automated test tool can be computed based upon the recorded time and in block 330, the automated test tool can repeatedly execute upon the application under test. For each execution of the automated test tool in block 335, in block 335 a running ROI can be computed and reported according to the difference between a number of uses of the automated test tool by the cost of manual execution less the development cost divided by the development cost.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for dynamic computation of return on investment (ROI) for test automation, the method comprising:
storing a development cost for an automated test tool configured to test an application under test, and also a cost of manually executing a test case for the application under test;
repeatedly executing the automated test tool for the application under test;
computing in a dynamic ROI calculator executing in memory by at least one processor of a computer, a running ROI as a difference between a number of executions of the automated test tool by the cost of manually executing the test case for the application under test less the development cost of the automated test tool divided by the development cost; and,
displaying the running ROI.

2. The method of claim 1, wherein storing a development cost for an automated test tool configured to test an application under test comprises:
developing the automated test tool in a test planning and execution environment and tracking during development an amount of time lapsing during the development;
computing the development cost for the automated test tool as a multiple of the amount of time lapsed during development; and,
storing the development cost.

3. The method of claim 2, wherein computing the development cost for the automated test tool as a multiple of the amount of time lapsed during development, comprises computing the development cost for the automated test tool as a multiple of the amount of time lapsed during development added to a cost of computing resource consumed by the test planning and execution environment during development.

4. The method of claim 1, wherein displaying the running ROI comprises printing a report of the ROI.

5. A test automation data processing system configured for dynamic computation of return on investment (ROI) for test automation, the system comprising:
a host computer with at least one processor and memory;
an operating system hosted by the host computer;
an automated test tool executing in the host computer through the operating system, the automated test tool testing an application under test; and,
a dynamic ROI calculator coupled to the automated test tool, the ROI calculator comprising program code enabled upon execution in the host computer to compute a running ROI for the automated test tool as a difference between a number of uses of the automated test tool by a cost of manual execution of a test case for the application under test less a development cost of the automated test tool divided by the development cost automated test tool, and to display the running ROI through the host computer.

6. The system of claim 5, wherein the development cost of the automated test tool is computed as a multiple of an amount of time tracked during development of the automated test tool.

7. The system of claim 5, wherein the development cost of the automated test tool is computed as a multiple of an amount of time tracked during development of the automated test tool and an amount of computing resources consumed during development of the automated test tool.

8. A computer program product for dynamic computation of return on investment (ROI) for test automation, the computer program product comprising:
a computer readable storage medium having computer readable program code embodied therewith, the computer readable program code comprising:
computer readable program code for storing a development cost for an automated test tool configured to test an application under test, and also a cost of manually executing a test case for the application under test;
computer readable program code for repeatedly executing the automated test tool for the application under test;
computer readable program code for computing a running ROI as a difference between a number of executions of the automated test tool by the cost of manually executing the test case for the application under test less the development cost of the automated test tool divided by the development cost; and,
computer readable program code for displaying the running ROI.

9. The computer program product of claim 8, wherein the computer readable program code for storing a development cost for an automated test tool configured to test an application under test comprises:
computer readable program code for developing the automated test tool in a test planning and execution environment and tracking during development an amount of time lapsing during the development;
computer readable program code for computing the development cost for the automated test tool as a multiple of the amount of time lapsed during development; and,
computer readable program code for storing the development cost.

10. The computer program product of claim 9, wherein the computer readable program code for computing the development cost for the automated test tool as a multiple of the amount of time lapsed during development, comprises computer readable program code for computing the development cost for the automated test tool as a multiple of the amount of time lapsed during development added to a cost of computing resource consumed by the test planning and execution environment during development.

11. The computer program product of claim 8, wherein the computer readable program code for displaying the running ROI comprises computer readable program code for printing a report of the ROI.
